(19) United States
(12) Patent Application Publication
(10) Pub. No.: US 2022/0188603 A1
(43) Pub. Date: Jun. 16, 2022

(54) Neural Network Learning Method, Neural Network Generation Method, Trained Device, Mobile Terminal Device, Learning Processing Device and Recording Medium

(71) Applicant: Kyoto University, Kyoto-shi, Kyoto (JP)

(72) Inventor: Junnosuke Teramae, Kyoto-shi, Kyoto (JP)

(21) Appl. No.: 17/440,037

(22) PCT Filed: Mar. 17, 2020
(86) PCT No.: PCT/JP2020/011577

§ 371 Date: Sep. 16, 2021

(30) Foreign Application Priority Data
Mar. 28, 2019 (JP) 2019-064222

(51) Int. Cl. G06N 3/04; G06N 3/08

(52) U.S. Cl. CPC G06N 3/0472; G06N 3/08; G06N 3/0481

(57) ABSTRACT

Provided are a neural network learning method, a neural network generation method, a trained device, a mobile terminal device, a learning processing device, and a recording medium not requiring use of an error backpropagation method.

Each neuron in a neural network is set to a random variable allowed to take a binary value, a connection weight between neurons is expressed as a plurality of synapses obtained by multiplying each synapse by a required connection coefficient, and the plurality of synapses is set to random variables allowed to take binary values, initial data is given to a neuron in a middle layer, a process of updating each state value of each neuron in the middle layer and each synapse in the neural network is repeated by performing sampling based on a Markov chain Monte Carlo method from a conditional probability distribution under a condition that a random variable of a neuron in each of the input layer and the output layer is a value of the training data, and a connection weight between neurons is calculated based on the updated state value of each synapse.

### CROSS-REFERENCE TO RELATED APPLICATIONS

This application is the national phase under 35 U.S.C. § 371 of PCT International Application No. PCT/JP2020/011577 which has an International filing date of Mar. 17, 2020 and designated the United States of America.

### FIELD

The present invention relates to a neural network learning method, a neural network generation method, a trained device, a mobile terminal device, a learning processing device, and a recording medium.

### BACKGROUND

A neural network is a basic technology that forms a substance of machine learning (artificial intelligence) that has been rapidly developing in recent years, and is generated by adjusting learning) a large number of parameters contained in the network using given training data.

Japanese Patent Laid-Open Publication No. 6-282531 discloses an approximate optimization method referred to as an error backpropagation method, which is mainly used in training of the neural network.

### SUMMARY

However, the error backpropagation method implements training by synchronously propagating an error calculated in an output layer throughout the network, and thus it is necessary to alternately repeat two types of calculations, a forward calculation for calculating an error from the input and a reverse calculation for propagating an error to the network. In addition, in the error backpropagation method, only a feedforward network can be applied, optimality is not ensured, it is necessary to artificially design an error function (objective function), overfitting is likely to occur, a large amount of data is required for learning, and it necessary to fine-tune a learning rate (learning parameter).

As described above, the error backpropagation method has various problems.

The disclosure has been made in view of such circumstances, and an object of the disclosure is to provide a neural network learning method, a neural network generation method, a trained device, a mobile terminal device, a learning processing device, and a recording medium not requiring use of the error backpropagation method.

A neural network learning method according to an embodiment of the present disclosure, comprising: setting each neuron in a neural network to a random variable allowed to take a binary value; expressing a connection weight between neurons in the neural network as a plurality of synapses obtained by multiplying each synapse by a required connection coefficient, and setting the plurality of synapses to random variables allowed to take binary values; giving training data to a neuron in each of an input layer and an output layer, and giving initial data to a neuron in a middle layer; repeating a process of updating each state value of each neuron in the middle layer and each synapse in the neural network by performing sampling based on a Markov chain Monte Carlo method from a conditional probability distribution under a condition that a random variable of a neuron in each of the input layer and the output layer is a value of the training data; and calculating a connection weight between neurons based on the updated state value of each synapse.

A neural network learning method according to an embodiment of the present disclosure, comprising: giving training data to a neuron in each of an input layer and an output layer of a neural network; giving initial data to a connection weight between neurons of a neural network and a neuron in the middle layer of the neural network; updating a state value of a neuron in the middle layer based on a value obtained by converting a sum of a sum of signal values input to the neuron and a bias value from a posterior neuron connected to the neuron by an activation function; and updating a connection weight between neurons based on an updated state value of each neuron.

A neural network generation method according to an embodiment of the present disclosure, comprising: setting each neuron in a neural network to a random variable allowed to take a binary value; expressing a connection weight between neurons in the neural network as a plurality of synapses obtained by multiplying each synapse by a required connection coefficient, and setting the plurality of synapses to random variables allowed to take binary values; giving training data to a neuron in each of an input layer and an output layer, and giving initial data to a neuron in a middle layer; repeating a process of updating each state value of each neuron in the middle layer and each synapse in the neural network by performing sampling based on a Markov chain Monte Carlo method from a conditional probability distribution under a condition that a random variable of a neuron in each of the input layer and the output layer is a value of the training data; and generating a neural network by calculating a connection weight between neurons based on an updated state value of each synapse.

A neural network generation method according to an embodiment of the present disclosure, comprising: giving training data to a neuron in each of an input layer and an output layer of a neural network; giving initial data to a connection weight between neurons of a neural network and a neuron in the middle layer of the neural network; updating a state value of a neuron in the middle layer based on a value obtained by converting a sum of a sum of signal values input to the neuron and a bias value from a posterior neuron connected to the neuron by an activation function; and updating a connection weight between neurons based on an updated state value of each neuron.

A trained device according to an embodiment of the present disclosure, the trained device having a neural network, the trained device being generated by causing a computer to execute processes of: setting each neuron in the neural network to a random variable allowed to take a binary value; expressing a connection weight between neurons in the neural network as a plurality of synapses obtained by multiplying each synapse by a required connection coefficient, and setting the plurality of synapses to random variables allowed to take binary values; giving training data to a neuron in each of an input layer and an output layer, and giving initial data to a neuron in a middle layer; repeatedly updating each state value of each neuron in the middle layer and each synapse in the neural network by performing sampling based on a Markov chain Monte Carlo method from a conditional probability distribution under a condition that a random variable of a neuron in each of the input layer and the output layer is a value of the training data; and calculating a connection weight between neurons based on the updated state value of each synapse.

A trained device according to an embodiment of the present disclosure, the trained device having a neural network, the trained device being generated by causing a computer to execute processes of giving training data to a neuron in each of an input layer and an output layer of the neural network; giving initial data to a connection weight between neurons of a neural network and a neuron in the middle layer of the neural network; updating a state value of a neuron in the middle layer based on a value obtained by converting a sum of a sum of signal values input to the neuron and a bias value from a posterior neuron connected to the neuron by an activation function; and updating a connection weight between neurons based on an updated state value of each neuron.

A mobile terminal device according to an embodiment of the present disclosure, the mobile terminal device comprising the trained device as mentioned above, the trained device being generated using at least one of image data, audio data, and character string data as training data.

A learning processing device according to an embodiment of the present disclosure, comprising a processor, the learning processing device training a neural network, the processor executing processes of setting each neuron in the neural network to a random variable allowed to take a binary value, expressing a connection weight between neurons in the neural network as a plurality of synapses obtained by multiplying each synapse by a required connection coefficient, and setting the plurality of synapses to random variables allowed to take binary values, giving training data to a neuron in each of an input layer and an output layer, and giving initial data to a neuron in a middle layer, repeatedly updating each state value of each neuron in the middle layer and each synapse in the neural network by performing sampling based on a Markov chain Monte Carlo method from a conditional probability distribution under a condition that a random variable of a neuron in each of the input layer and the output layer is a value of the training data, and calculating a connection weight between neurons based on the updated state value of each synapse.

A learning processing device according to an embodiment of the present disclosure, comprising a processor, the learning processing device training a neural network, the processor executing processes of giving training data to a neuron in each of an input layer and an output layer of a neural network, giving initial data to a connection weight between neurons of a neural network and a neuron in the middle layer of the neural network, updating a state value of a neuron in the middle layer based on a value obtained by converting a sum of a sum of signal values input to the neuron and a bias value from a posterior neuron connected to the neuron by an activation function, and updating a connection weight between neurons based on an updated state value of each neuron.

A computer readable non-transitory recording medium recording a computer program according to an embodiment of the present disclosure, causing a computer to execute processes of setting each neuron in a neural network to a random variable allowed to take a binary value; expressing a connection weight between neurons in the neural network as a plurality of synapses obtained by multiplying each synapse by a required connection coefficient, and setting the plurality of synapses to random variables allowed to take binary values; giving training data to a neuron in each of an input layer and an output layer, and giving initial data to a neuron in a middle layer; repeatedly updating each state value of each neuron in the middle layer and each synapse in the neural network by performing sampling based on a Markov chain Monte Carlo method from a conditional probability distribution under a condition that a random variable of a neuron in each of the input layer and the output layer is a value of the training data; and calculating a connection weight between neurons based on the updated state value of each synapse.

A computer readable non-transitory recording medium recording a computer program according to an embodiment of the present disclosure, causing a computer to execute processes of: giving training data to a neuron in each of an input layer and an output layer of a neural network; giving initial data to a connection weight between neurons of a neural network and a neuron in the middle layer of the neural network; updating a state value of a neuron in the middle layer based on a value obtained by converting a sum of a sum of signal values input to the neuron and a bias value from a posterior neuron connected to the neuron by an activation function; and updating a connection weight between neurons based on an updated state value of each neuron.

According to the present disclosure, it is unnecessary to use the error backpropagation method, and learning can be performed by only one type of calculation, and network learning can be implemented by local and asynchronous calculation.

The above and further objects and features of the invention will more fully be apparent from the following detailed description with accompanying drawings.

### BRIEF DESCRIPTION OF THE DRAWINGS

FIG. 1 is a schematic view illustrating an example of a configuration of a neural network.

FIG. 2 is a schematic view illustrating an example of a configuration of a synapse of the present embodiment.

FIG. 3 is a schematic view illustrating an outline of a neural network learning method.

FIG. 4 is a schematic view illustrating an example of the sum of signals input to a neuron.

FIG. 5 is a schematic view illustrating an example of an appearance of a bias from a posterior neuron.

FIG. 6 is an explanatory diagram illustrating an example of Gibbs sampling processing.

FIG. 7 is a schematic view illustrating an example of an appearance of a synapse connecting an anterior neuron and a posterior neuron.

FIG. 8A is a schematic view illustrating an example of a configuration of a recurrent neural network.

FIG. 8B is a schematic view illustrating an example of the configuration of the recurrent neural network.

FIG. 9 is a block diagram illustrating an example of a configuration of an information processing device used for learning of the neural network.

FIG. 10 is a flowchart illustrating an example of a processing procedure of learning of the neural network.

FIG. 11 is an explanatory diagram illustrating a first evaluation result by a learning method of the present embodiment.

FIG. 12 is an explanatory diagram illustrating a second evaluation result by the learning method of the present embodiment.

FIG. 13 is an explanatory diagram illustrating a third evaluation result by the learning method of the present embodiment.

FIG. 14 is a schematic view illustrating an example of a configuration of a synapse of a second embodiment.

FIG. 15 is a schematic view illustrating an outline of a neural network learning method in the second embodiment.

FIG. 16 is a schematic view illustrating an example of an appearance of a bias from a posterior neuron.

FIG. 17 is a schematic view illustrating an example of an appearance of a connection weight connecting an anterior neuron and a posterior neuron.

FIG. 18 is a flowchart illustrating an example of a processing procedure of learning of the neural network of the second embodiment.

FIG. 19 is an explanatory diagram illustrating an example of an evaluation result by a learning method of the second embodiment.

FIG. 20 is a block diagram illustrating an example of a configuration of a mobile terminal device.

### FIRST EMBODIMENT

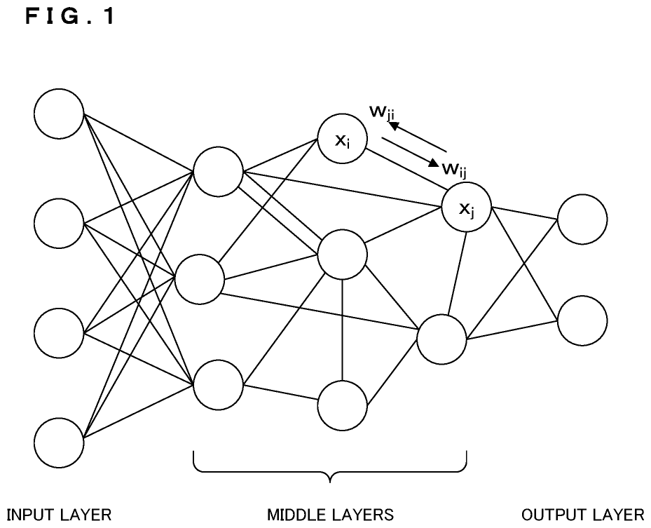

Hereinafter, the invention will be described with reference to the drawings illustrating embodiments thereof. FIG. 1 is a schematic view illustrating an example of a configuration of a neural network. The neural network includes an input layer, an output layer, and a plurality of middle layers. Note that even though three middle layers are illustrated in FIG. 1, the number of middle layers is not limited to three.

Neurons (indicated by circles in the figure) exist in an input layer, an output layer, and middle layers, and adjacent neurons are connected by a connection weight. As illustrated in FIG. 1, an i-th neuron is denoted by xᵢ and a j-th neuron is denoted by xⱼ. i and j are indexes of neuron numbers. A connection weight from the neuron xᵢ to the neuron xⱼ is denoted by wᵢⱼ, and a connection weight from the neuron xⱼ to the neuron xᵢ is denoted by wⱼᵢ. Here, wᵢⱼ and wⱼᵢ may have the same value or different values. In general, wᵢⱼ and wⱼᵢ may have different values.

In the present embodiment, each neuron in the neural network is a random variable that can take a binary value. The binary value can be, for example, “1” or “0”, and the random variable can be a variable that can take a binary value determined according to a probability of a value converted by an activation function. For example, each neuron xᵢ takes a value of 0 or 1. xᵢ=1 indicates that the neuron is in a firing state, and xᵢ=0 indicates that the neuron is in a non-firing state.

Each neuron takes 1 with a probability based on an equation represented by Equation (1). m denotes an index of a neuron number. Σ denotes, for example, the sum of m=1 to M. M denotes the number of neurons that give an input signal to the neuron xᵢ. σ denotes an activation function of a neuron, and can be a sigmoid function represented by Equation (2).

$$\begin{matrix}p ( {x}_{i} = 1 ) = σ ( {v}_{i} ) = σ ( {\sum }_{m} {x}_{m} \cdot {w}_{mi} ) & ( 1 ) \\ σ ( v ) = \frac{1}{1 + {e}^{- v}} & ( 2 )\end{matrix}$$

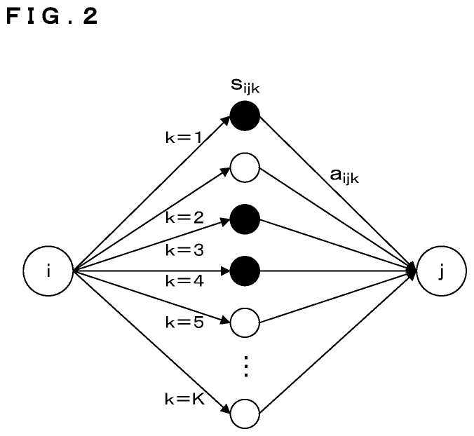

FIG. 2 is a schematic view illustrating an example of a configuration of a synapse of the present embodiment. As illustrated in FIG. 2, in the present embodiment, a connection weight between neurons in the neural network is decomposed into a plurality of synapses multiplied by required connection coefficients, respectively. For example, as illustrated in FIG. 2, assuming that the connection weight from the neuron xᵢ to the neuron xⱼ is set to wᵢⱼ, and a synapse is set to sᵢⱼₖ, the connection weight wᵢⱼ can be represented by Equation (3).

$${w}_{ij} = {\sum }_{k} {s}_{i j k} \cdot {a}_{ijk} \qquad ( 3 )$$

Here, aᵢⱼₖ denotes a required connection coefficient and can be a relatively small constant that does not change by learning. Σ denotes, for example, the sum of k=1 to K.

Similarly, assuming that the connection weight from the neuron xⱼ to the neuron xᵢ is set to wᵢⱼ, and a synapse is set to sⱼᵢₖ, the connection weight can be represented by wᵢⱼ=Σsⱼᵢₖ·aⱼᵢₖ. Here, aⱼᵢₖ denotes a required connection coefficient and can be a relatively small constant that does not change by learning. E denotes, for example, the sum of k=1 to K.

Further, in the present embodiment, each synapse in the neural network is a random variable that can take a binary value. The binary value can be, for example, “1” or “0”, and the random variable can be a variable that can take a binary value determined according to a probability of a value converted by the activation function. For example, the synapse sᵢⱼₖ takes a value of 0 or 1. sᵢⱼₖ=1 represents a connection state, and sᵢⱼₖ=0 represents a non-connection state. In FIG. 2, black circles and white circles schematically indicate that binary values can be taken.

In the neural network learning method, training data is given to neurons in the input layer and output layer, and initial data is given to neurons in the middle layers. Then, from a conditional probability distribution under a condition that the random variables of the neurons in the input layer and the output layer are the values of the training data, sampling based on the Markov chain Monte Carlo method is performed, and a process of updating a state value of each neuron in the middle layers and each synapse in the neural network is repeated.

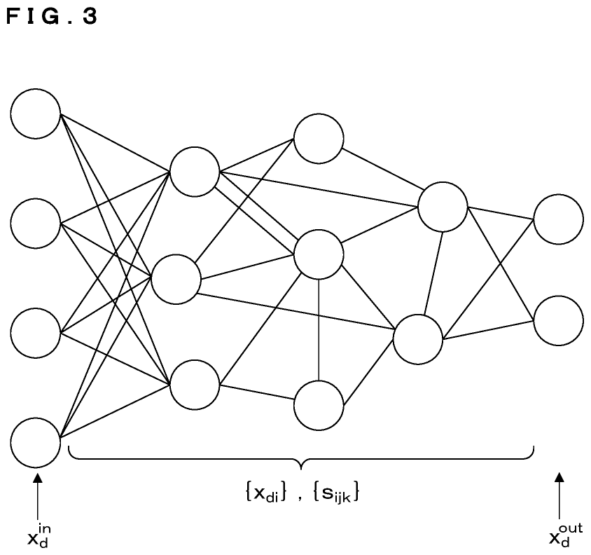

FIG. 3 is a schematic view illustrating an outline of a neural network learning method. As illustrated in FIG. 3, the neurons in the input layer are fixed to a state x_{d}ⁱⁿ of the neurons corresponding to training data of a data index d. The neurons in the output layer are fixed to a state x_{d}^{out} of the neurons corresponding to training data of a data index d. The state of all neurons in the middle layers is represented by {x_{di}}. Moreover, the state of all synapses in the middle layers is represented by {sᵢⱼₖ}. Sampling based on the Markov chain Monte Carlo method repeats a process of sampling and updating the state {x_{di}} of all the neurons in the middle layers and the state {sᵢⱼₖ} of all the synapses in the middle layers from the conditional probability distribution P under the condition that the state x_{d}ⁱⁿ of the neurons in the input layer and the state x_{d}^{out} of the neurons in the output layer are given as represented by Equation (4).

p({x_{di}},{sᵢⱼₖ}|{x_{d}ⁱⁿ},{x_{d}^{out}}) (4)

That is, both the spike firing activity of neurons and the appearance of synaptic changes (synaptic plasticity) are treated in a unified manner, and sampling from the conditional probability distribution under a given condition of training data (input data for learning and teacher data) is repeated, so that a state value of each neuron in the middle layers and each synapse in the neural network is updated. In this case, the state value of the neuron in the input layer and the state value of the neuron in the output layer are fixed to values of the training data.

The Markov chain Monte Carlo method includes, for example, the Gibbs sampling method, the Metropolis Hasting method, etc. In these sampling methods, by repeating sampling, there is a property that a sampled value does not depend on an initial value (for example, initial data given to the neurons in the middle layers), and converges to the sampled value from the true distribution.

That is, by using a required update rule described below, sampling from the conditional probability distribution can be performed under a condition that neurons in the input layer and neurons in the output layer are fixed to the training data, and it is possible to obtain each value of each neuron in the middle layers and each synapse in the neural network. Further, a sampling order is not limited, and the sampling order may be a specific order or may be random.

For each neuron in the middle layers, an influence from an anterior neuron (input side neuron) and a posterior neuron (output side neuron) connected to the neuron may be considered. In addition, for each synapse, an influence from the anterior neuron and the posterior neuron to which the synapse is connected may be considered. Therefore, calculations can be performed locally and asynchronously without the need to consider a global state of the network.

A connection weight between neurons is calculated based on an updated state value of each synapse. Calculation of the connection weight can be obtained from Equation (3), that is, the equation wᵢⱼ=Σsᵢⱼₖ·aᵢⱼₖ. aᵢⱼₖ can be a relatively small constant, and the sum K of the number of constants can be set to an appropriate value. A value of the connection weight wᵢⱼ can be set to an appropriate value simply by setting the value of each synapse sᵢⱼₖ to 1 or 0.

As described above, it is unnecessary to use the error backpropagation method, learning can be performed with only one type of calculation, network learning can be implemented by local and asynchronous calculation, and application to various networks is allowed. Further, when design of an error function is unnecessary, a learning rate is unnecessary, and there are a sufficient number of pieces of data, the optimum is ensured.

Next, a neuron update rule and a synapse update rule will be described. Further, in the following, the Gibbs sampling method will be used for description. First, the neuron update rule will be described.

A state value of a neuron in the middle layers is updated based on values obtained by converting the sum of signal values input to the neuron and the sum of bias values from the posterior neuron connected to the neuron using an activation function. More specifically, the state value of the neuron in the middle layers is updated to 1 with a probability of the value converted by the activation function. The value converted by the activation function can take a value from 0 to 1. When the converted value is, for example, 0.8, the state value of the neuron in the middle layers is updated to 1 with a probability of 0.8, and updated to 0 with a remaining probability of 0.2 (=1·0.8).

Each neuron in the middle layers can be updated based on an equation represented by Equation (5).

$$\begin{matrix}p ( {x}_{di} = 1 ) = σ ( {v}_{di} + {b}_{di} ) & ( 5 ) \\ {b}_{di} = {\sum }_{j} \{ {x}_{dj} - σ ( {v}_{dj} ) \} \cdot {w}_{ij} & ( 6 )\end{matrix}$$

σ is an activation function (for example, sigmoid function). d is an index of data and is also a mini-batch index used to update all neurons in the middle layers once.

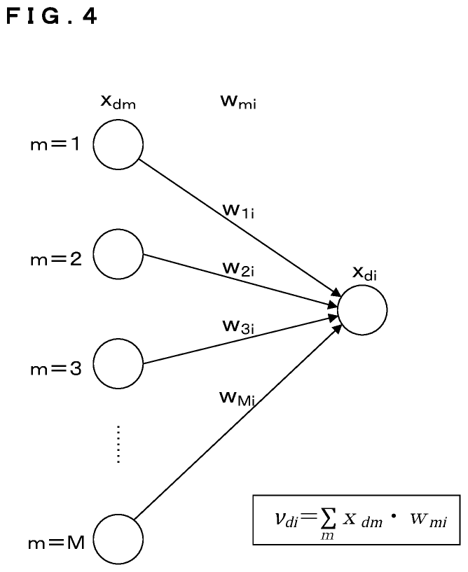

FIG. 4 is a schematic view illustrating an example of the sum of signals input to a neuron. As illustrated in FIG. 4, the sum v_{di} of signal values input to a neuron x_{di} is represented by an equation v_{di}=(Σx_{dm}·wₘᵢ) (for convenience, m under Σ is omitted), and Σ denotes, for example, the sum from m=1 to M. M denotes the number of neurons (anterior neurons) connected on the input side of the neuron x_{di}.

In Equation (5), b_{di} can give a bias of a firing probability from the posterior neuron to the neuron x_{di}. That is, the presence of the retrograde bias term b_{di} makes it possible to spread information of the training data given to the neurons in the output layer to the middle layers of the network. In this sense, the bias term b_{di} can be regarded as a stochastic expression based on the sampling of error propagation in the error backpropagation method. In this way, it is possible to perform learning based on the information of the training data given to the neurons in the output layer without using error backpropagation.

Next, the bias term b_{di} will be described.

The bias value from the posterior neuron is calculated based on a difference between a state value of the posterior neuron and an expected value of the posterior neuron. The bias value b_{di} can be calculated by Equation (6). In Equation (6), x_{dj} denotes a state value of the posterior neuron xⱼ, and σ(v_{dj}) denotes an expected value (predicted value) of the state of the posterior neuron obtained by the sum of signals input to the posterior neuron xⱼ.

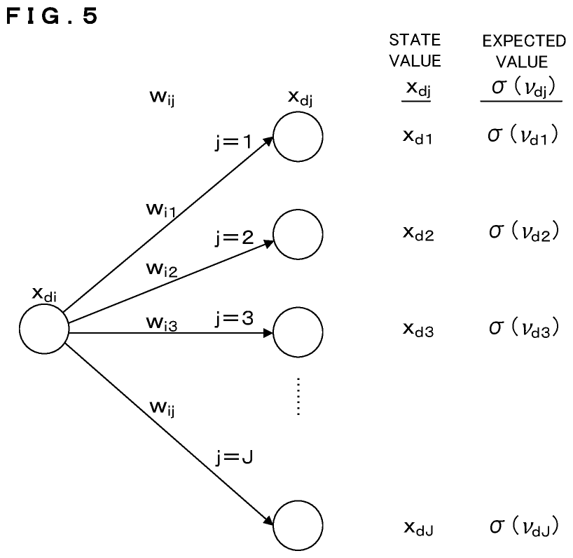

FIG. 5 is a schematic view illustrating an example of an appearance of a bias from the posterior neuron. As illustrated in FIG. 5, a posterior neuron of the neuron x_{di} is denoted by x_{dj}. j can be, for example, j=1 to J. J is the number of posterior neurons.

The meaning of Equation (6) is that when the state of the posterior neuron is larger than the expected value, the bias value b_{di} becomes positive, so that (v_{di}+b_{di}) of an equation P(x_{di}=1)=σ(v_{di}+b_{di}) increases, which has the effect of facilitating firing of the neuron xᵢ. In addition, when the state of the posterior neuron is smaller than the expected value, the bias value b_{di} becomes negative, so that (v_{di}+b_{di}) of the equation P(x_{di}=1)=σ(v_{di}+b_{di}) decreases, which has the effect of making it difficult to fire the neuron xᵢ.

Thus, Equation (6) can be regarded as retrograde error propagation, and unlike the conventional error backpropagation method, this retrograde error propagation is implemented without the need for coordinated operation of the entire network.

In the Gibbs sampling method, sampling is performed based on Equations (5) and (6) as a required update rule for each neuron in the middle layers.

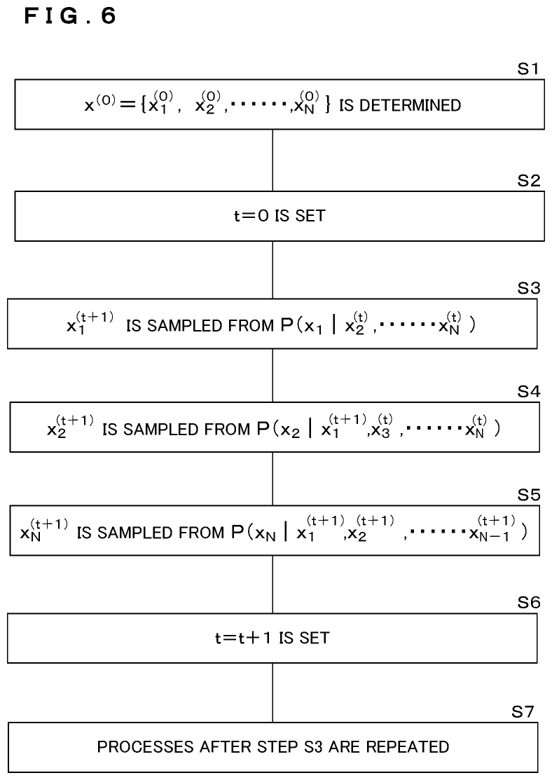

FIG. 6 is an explanatory diagram illustrating an example of Gibbs sampling processing. Note that in FIG. 6, the random variables are described as xᵢ, . . . , x_{N} for convenience. First, in step S1, an initial value x⁽⁰⁾={x₁⁽⁰⁾, x₂⁽⁰⁾, . . . , x_{N}⁽⁰⁾} is determined. In step S2, t=0 is set. In step S3, x₁⁽¹⁾ is sampled under a condition that x₂⁽⁰⁾, . . . , x_{N}⁽⁰⁾ are given. Here, a value of x₁⁽¹⁾ is obtained. In step S4, x₂⁽¹⁾ is sampled under a condition that x₁⁽¹⁾, x₃⁽⁰⁾, . . . , x_{N}⁽⁰⁾ are given using the value of x₁⁽¹⁾ obtained in step S3. Hereinafter, x_{N}⁽¹⁾ is sampled in the same manner. In this way, x₁⁽¹⁾, x₂⁽¹⁾, . . . , x_{N}⁽¹⁾ can be obtained. In step S6, t=t+1 is set, and in step S7, the processes after step S3 are repeated.

Gibbs sampling is a method that implements sampling from the true distribution (now a true posterior distribution) by repeating sampling for each variable, and after a sufficient number of repetitions, the fact that sampling from the true distribution can be implemented is ensured. A value sampled from the posterior distribution is guaranteed to match an optimal solution (maximum log-likelihood of the teacher data) when the number of pieces of data is large.

Next, the synapse update rule will be described.

State values of a plurality of synapses connecting an anterior neuron and a posterior neuron are updated to values based on a state value of the anterior neuron and a state value of the posterior neuron.

The plurality of synapses sᵢⱼₖ connecting the anterior neuron and the posterior neuron can be updated based on Equation (7).

$$\begin{matrix}p ( {s}_{ijk} = 1 ) = σ ( {q}_{o , ijk} + {q}_{ijk} ) & ( 7 ) \\ {q}_{ijk} = {a}_{ijk} = {\sum }_{d} {x}_{di} ( {x}_{dj} - σ ( {v}_{dj} ) ) & ( 8 )\end{matrix}$$

In Equation (7), a is an activation function (for example, sigmoid function). q_{0,ijk} is an initial value, and may be set to 0, for example. qᵢⱼₖ is a bias term that depends on the state of the anterior neuron and the state of the posterior neuron. When the state of the anterior neuron is non-firing (x_{di}=0), synapses need not be considered. Further, when the state of the anterior neuron is firing (x_{di}=1), the states of the plurality of synapses can be updated by a bias according to the state of the posterior neuron.

Next, the bias term qᵢⱼₖ will be described.

More specifically, the state values of the plurality of synapses connecting the anterior neuron and the posterior neuron can be updated based on a value obtained by converting a value, which is obtained by multiplying the state value of the anterior neuron by a difference between the state value of the posterior neuron and the expected value of the posterior neuron, using the activation function. That is, the state value of the synapse is updated to 1 with a probability of the value converted by the activation function, and is updated to 0 with a remaining probability. When the converted value is, for example, 0.8, the state value of the synapse is updated to 1 with a probability of 0.8, and is updated to 0 with a remaining probability of 0.2 (=1−0.8).

The bias term qᵢⱼₖ can be updated by Equation (8). In Equation (8), Σ is the sum of data indexes d. That is. Σ is the sum of each index d of the mini-batch used when updating all neurons in the middle layers once, and in the calculation of the sum by Σ, each neuron in the middle layers is updated for each piece of data, whereas the synapse update in the neural network is the sum for all pieces of the data. σ is an activation function (for example, sigmoid function).

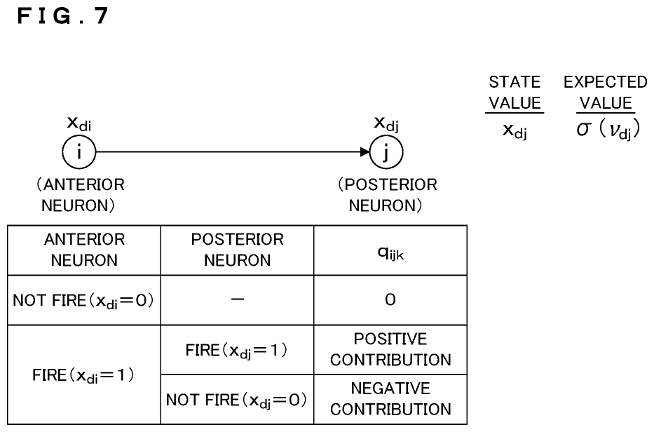

FIG. 7 is a schematic view illustrating an example of an appearance of a synapse connecting the anterior neuron and the posterior neuron. x_{di} denotes a state value of the anterior neuron. x_{dj} denotes a state value of the posterior neuron. σ(v_{dj}) denotes an expected value of the state of the posterior neuron obtained by the sum of signals input to the posterior neuron xᵢ.

When the anterior neuron does not fire, x_{di}=0 and the bias term qᵢⱼₖ is 0. When the anterior neuron fires (x_{di}=1) and the posterior neuron x_{dj} fires (x_{dj}=1), a positive contribution is given to the bias term qᵢⱼₖ and the synapse is enhanced (resulting in a larger connection weight wᵢⱼ). When the posterior neuron x_{dj} does not fire (x_{dj}=0), a negative contribution is given to the bias term qᵢⱼₖ and the synapse is suppressed (resulting in a smaller connection weight wᵢⱼ).

The state value of each synapse in the neural network can be updated using the updated state value of each neuron in the middle layers. That is, using the data for each index d, all neurons in the middle layers are updated once for each piece of data. Then, the state value of each synapse in the neural network is obtained by using the values of all the neurons updated for the data of all the indexes d. In this way, states of all neurons in the middle layers are determined for each piece of data (for example, mini-batch data), and the state of each synapse in the neural network can be obtained based on the state of all neurons determined for data of all indexes.

In other words, synapses are known to behave stochastically in the brain in the same way as neurons, and stochastic movements of the synapses are implemented on a slower scale than that of neuron movements. The above configuration means that the synapse update operates on a slower time scale with respect to the neuron update, leading to neurons and synapses following different time-scale stochastic update rules.

The present embodiment can be applied to various neural networks such as recurrent neural networks.

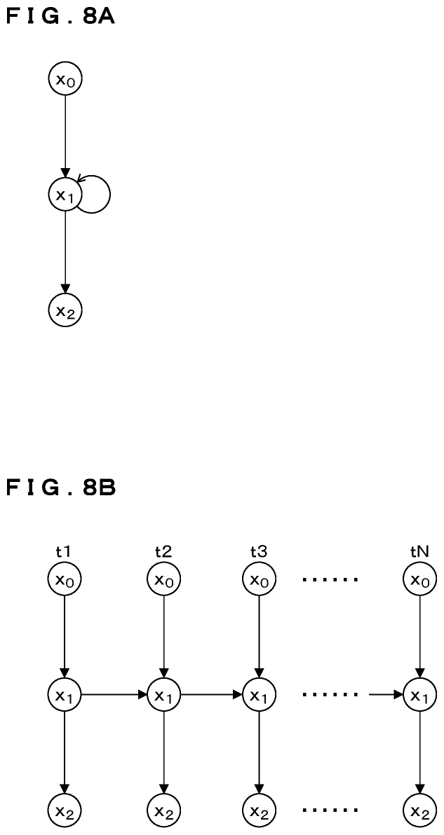

FIGS. 8A and 8B are schematic views illustrating an example of a configuration of a recurrent neural network. For convenience, a recurrent neural network including an input layer, one middle layers, and an output layer as illustrated in FIG. 8A is considered. x₀, x₁, and x₂ are neurons in the input layer, the middle layers, and the output layer.

FIG. 8B is an expansion of a loop structure of the middle layers illustrated in FIG. 8A, and can be configured as a general neural network as illustrated in FIG. 1, and the update rule described above can be used to update all neurons in the middle layers and each synapse of the neural network. Note that the expansion of FIG. 8B may not be adopted.

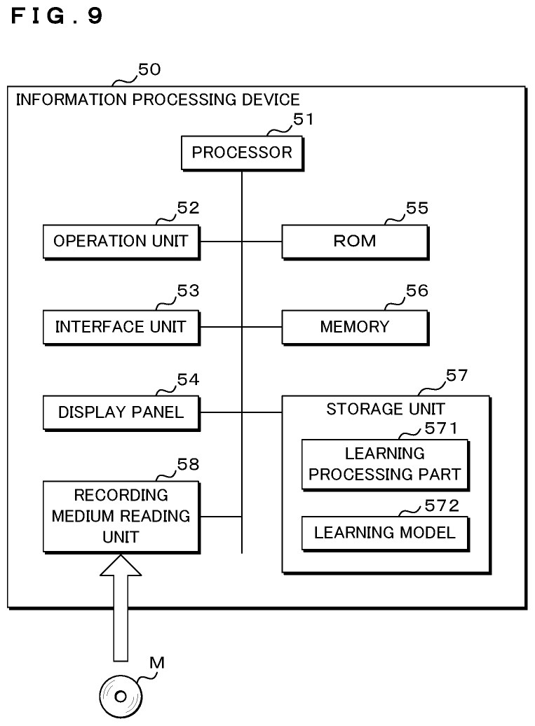

FIG. 9 is a block diagram illustrating an example of a configuration of an information processing device 50 used for learning of the neural network. The information processing device 50 as a learning processing device includes a processor 51, an operation unit 52, an interface unit 53, a display panel 54, a ROM 55, a memory 56 (for example, RAM), a storage unit 57, and a recording medium reading unit 58. The storage unit 57 stores a learning processing part 571 and a learning model 572 including computer programs and data for learning of the neural network. Note that the learning model 572 has a neural network, and can be a learning model (trained device) before, during, or after training. Note that the information processing device 50 may be configured as one device or configured as a plurality of devices. In this case, each unit of the information processing device 50 can be distributed and configured by the plurality of devices. For example, at least one of the learning processing part 571 and the learning model 572 may be provided in another device different from the information processing device 50. Further, the learning processing part 571 and the learning model 572 may be provided in other devices different from the information processing device 50, respectively.

For example, the processor 51 and the learning processing part 571 can be configured by combining hardware such as a CPU (for example, one processor or a multiple processors equipped with a plurality of processor cores), graphics processing units (GPU), digital signal processors (DSP), and field-programmable gate arrays (FPGA).

The display panel 54 may include a liquid crystal panel, an organic electro luminescence (EL) display, etc.

The operation unit 52 includes, for example, a hardware keyboard, a mouse, etc., and can operate an icon, etc. displayed on the display panel 24 and input characters, etc. Note that the operation unit 52 may include a touch panel.

The interface unit 53 can acquire training data, test data, etc. necessary for learning of the neural network from an external device, etc. Further, the interface unit 53 can output data, etc. obtained in a process of learning of the neural network.

The storage unit 57 may include a hard disk, a flash memory, etc. Learning of the neural network can be performed by reading the learning processing part 571 and the learning model 572 stored in the storage unit 57 into the memory 56 and processing the learning processing part 571 and the learning model 572 by the processor 51.

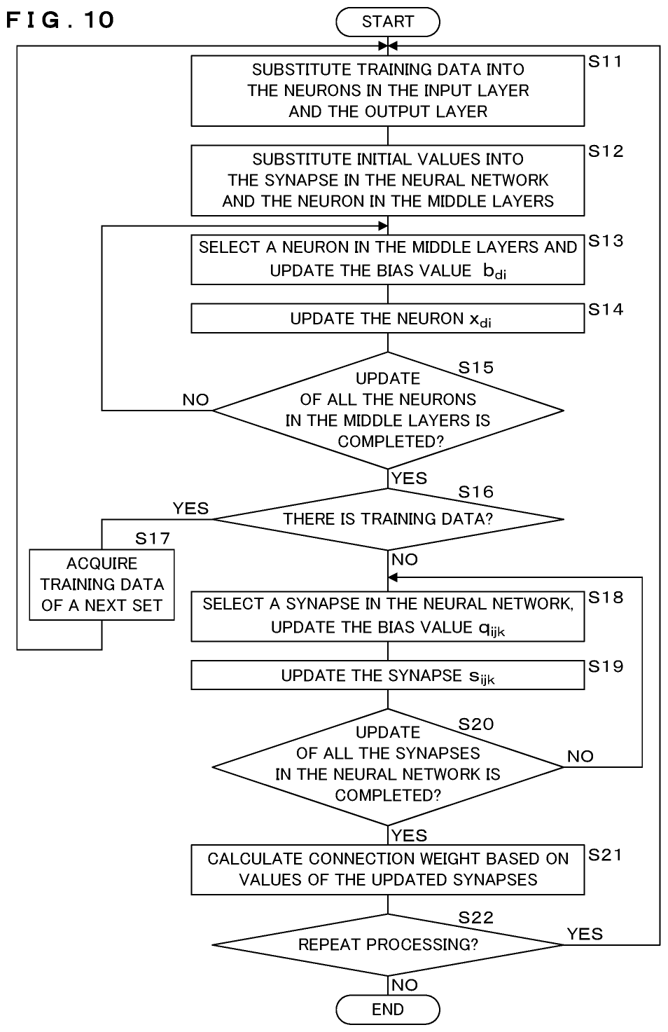

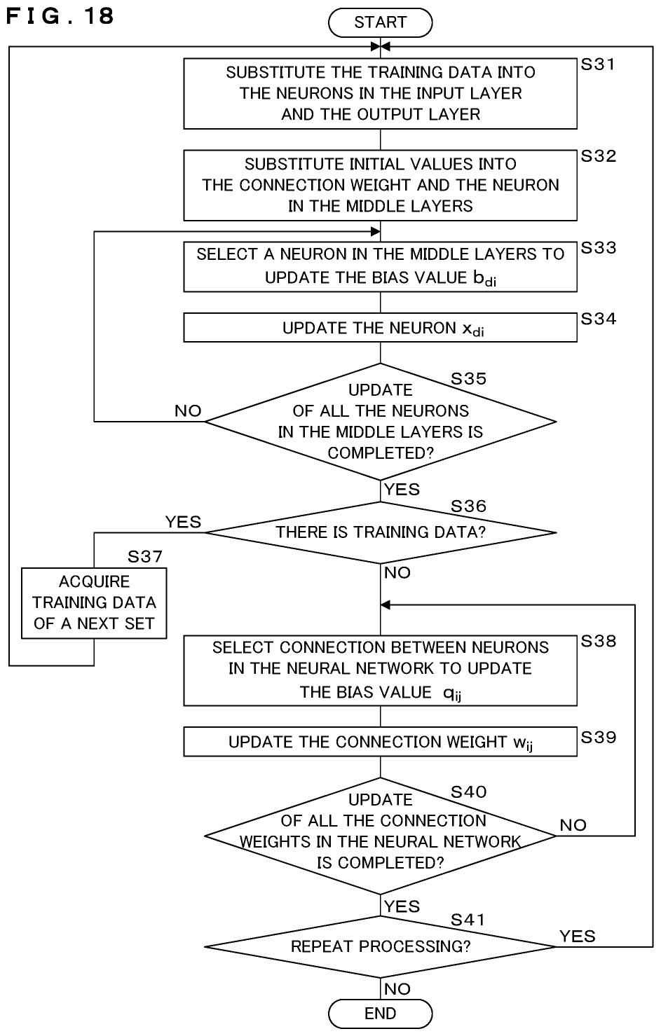

The recording medium reading unit 58 can read a computer program (for example, a processing procedure illustrated in FIGS. 10 and 18) from a recording medium M (for example, a medium such as a DVD) on which the computer program is recorded. Note that although not illustrated, the computer program recorded on the recording medium M is not limited to one recorded on a medium that can be freely carried, and can include a computer program transmitted via the Internet or other communication lines.

The learning processing part 571 (which may include the processor 51) can execute a process of setting each neuron in the neural network to a random variable that can take a binary value, a process of expressing a connection weight between neurons in the neural network as a plurality of synapses obtained by multiplying each synapse by a required connection coefficient, and setting the plurality of synapses to random variables allowed to take binary values, a process of giving training data to neurons in each of the input layer and output layer and giving initial data to neurons in the middle layers, a process of repeatedly updating each state value of each neuron in the middle layers and each synapse in the neural network by performing sampling based on the Markov chain Monte Carlo method from a conditional probability distribution under a condition that a random variable of a neuron in each of the input layer and the output layer is a value of the training data, and a process of calculating a connection weight between neurons based on the updated state value of each synapse.

FIG. 10 is a flowchart illustrating an example of a processing procedure of learning of the neural network. In the following, for convenience, a subject of processing will be described as the processor 51. The processor 51 substitutes the training data into the neurons in the input layer and the output layer (S11), and substitutes initial values into the synapse in the neural network and the neuron in the middle layers (S12).

The processor 51 selects a neuron in the middle layers and updates the bias value bᵢ based on Equation (6) (S13), and updates the neuron x_{di} based on Equation (5) (S14). The processor 51 determines whether or not the update of all the neurons in the middle layers is completed (S15), and when the update of all the neurons is completed (NO in S15), processing of step S13 and subsequent steps is repeated.

When the update of all the neurons is completed (YES in S15), that is, when the update is completed using data of one index, the processor 51 determines whether or not there is training data (S16). In step S16, it is determined whether or not there is data of another index that is not used for updating.

When there is training data (YES in S16), the processor 51 acquires training data of a next set (that is, a next index) (S17), and repeats processing of step S11 and subsequent steps. When the training data is not present (NO in S16), the processor 51 selects a synapse in the neural network, updates the bias value qᵢⱼₖ based on Equation (8) (S18), and updates the synapse sᵢⱼₖ based on Equation (7) (S19).

The processor 51 determines whether or not the update of all the synapses in the neural network is completed (S20), and when the update of all the synapses is not completed (NO in S20), processing of step S18 and subsequent steps is repeated. When the update of all the synapses is completed (YES in S20), the processor 51 calculates the connection weight wᵢⱼ based on values of the updated synapses (S21).

The processor 51 determines whether or not to repeat the processing (S22). Whether or not to repeat the processing may be determined by, for example, evaluating a performance of the connection weight calculated in step S21 and based on whether a required performance is obtained, or determined based on whether the processing is completed a predetermined number of times. The processor 51 repeats processing of step S11 and subsequent steps when the processing is repeated (YES in S22), and ends the processing when the processing is not repeated (NO in S22).

In the above-described embodiment, the update rules represented by Equations (6) and (8) can be updated more accurately by using Equations (9) and (10), respectively. Here, f_{dj}(x) can be represented by Equation (11), v_{dj,-i} can be represented by Equation (12), and v_{dj,-i} can be represented by Equation (13). Here, when a state of an i-th neuron is obtained by sampling, the contribution of the i-th neuron is excluded. Further, when a state of qᵢⱼₖ is sampled, the contribution of qᵢⱼₖ is excluded, and thus Gibbs sampling can be applied more accurately.

$$\begin{matrix} {b}_{di} = {\sum }_{j} ( log {f}_{dj} ( {v}_{dj , - i} + {w}_{ij} ) - log {f}_{dj} ( {v}_{dj , - i} ) ) & ( 9 ) \\ {q}_{ijk} = {\sum }_{d} ( log {f}_{dj} ( {v}_{dj , - ik} + {a}_{ijk} {x}_{di} ) - log {f}_{dj} ( {v}_{dj , - ik} ) ) & ( 10 ) \\ {f}_{dj} ( x ) = \{ \begin{matrix}σ ( x ) , & {x}_{dj}^{1} = 1 \\ 1 - σ ( x ) , & {x}_{dj}^{1} = 0\end{matrix} & ( 11 ) \\ {v}_{dj , - 1} = {v}_{dj} - {x}_{di} {w}_{ij} & ( 12 ) \\ {v}_{dj , - ik} = {v}_{dj} - {x}_{di} {s}_{ijk} {a}_{ijk} & ( 13 ) \\ {b}_{di} = ( 1 - {r}_{b} ) {b}_{di} + {r}_{b} {\sum }_{j} ( log {f}_{dj} ( {v}_{dj , - i} + {w}_{ij} ) - log {f}_{dj} ( {v}_{dj , - i} ) ) & ( 14 ) \\ {q}_{ijk} = ( 1 - {r}_{q} ) {q}_{ijk} + {r}_{q} {\sum }_{d} ( log {f}_{dj} ( {v}_{dj , - ik} + {a}_{ijk} {x}_{di} ) - log {f}_{dj} ( {v}_{dj , - ik} ) ) & ( 15 ) \\ p ( {x}_{di} = 1 ) = ( 1 - {r}_{x} ) {x}_{di} + {r}_{x} σ ( {v}_{di} + {b}_{di} ) & ( 16 ) \\ p ( {s}_{ijk} = 1 ) = ( 1 - {r}_{s} ) {s}_{ijk} + {r}_{s} σ ( {q}_{0 , ijk} + {q}_{ijk} ) & ( 17 )\end{matrix}$$

Further, in the above-described embodiment, Equations (14) and (15) can be used instead of the update rules shown in Equations (6) and (8), respectively. Here, a current value of b_{di} is reflected in the update of b_{di}, and a current value of qᵢⱼₖ is reflected in the update of qᵢⱼₖ.

Similarly, in the above-described embodiment, Equations (16) and (17) can be used instead of the update rules shown in Equations (5) and (7), respectively. Here, a current value of x_{di} is reflected in the update of x_{di}, and a current value of sᵢⱼₖ is reflected in the update of sᵢⱼₖ. Equations (14) to (17) correspond to sampling by the Metropolis Hasting method.

In Equations (16) and (17), for example, rₓ and rₛ may be set to values greater than 0 and less than 1. Equations (16) and (17) mean that sampling of each neuron and each synapse is performed with probabilities of rₓ and rs, and a status quo is biased to maintain a current value without performing sampling with probabilities of (1−rₓ) and (1−rₛ). Note that introduction of this status quo probability can be derived as a change in the proposed distribution in the Metropolis Hasting method.

Further, by using Equations (14) to (17), when a synchronous parallel computer such as a GPU is used, only some neurons and synapses in the network may be updated even if the synchronization is updated. That is, since only some neurons and synapses are updated, it is possible to prevent unnecessary time from realizing asynchronous update and to efficiently perform calculations by a parallel computer.

When the number of connection weights is set to W, the number of pieces of data is set to D, the number of synapses per connection is set to K, and the number of pieces of data is large, the order of the amount of calculation required for the learning method of the present embodiment is O(W(D+K))=O(WD), which is similar to that in the error backpropagation method.

The trained device generated by the learning method of the present embodiment can be incorporated into, for example, a mobile terminal device, etc. In this case, the trained device can be generated using at least one of image data, audio data, and character string data as training data. In this way, when image data is input, the mobile terminal device can perform processing such as image recognition and image classification to detect a required object. When audio data is input, the mobile terminal device can perform processing such as audio recognition. In addition, when character string data is input, the mobile terminal device can perform natural language processing, etc.

Next, effectiveness of the learning method of the present embodiment will be described.

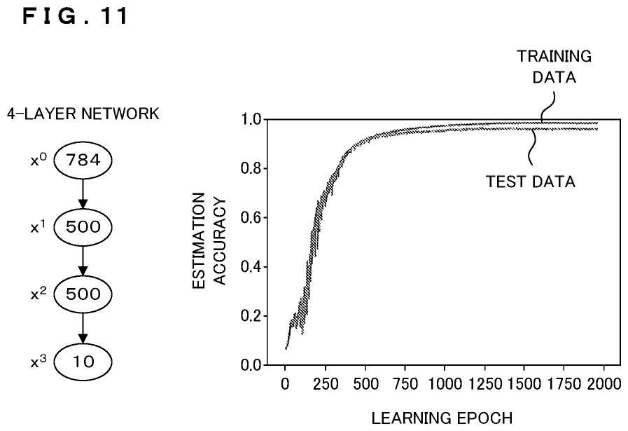

FIG. 11 is an explanatory diagram illustrating a first evaluation result by the learning method of the present embodiment. FIG. 11 illustrates the evaluation result using a typical handwritten character recognition data set (MNIST) frequently used in machine learning. The neural network includes an input layer, two middle layers, and an output layer. The number of neurons in the input layer is set to 784, the number of neurons in the output layer is set to 10, and the number of neurons in each of the middle layers is set to 500. 60,000 pieces of data are used in one sampling. One epoch corresponds to the number of times when all the training data is used up in learning. As illustrated in FIG. 11, it can be seen that the estimation accuracy based on the training data and the estimation accuracy based on the test data are changing in the same manner.

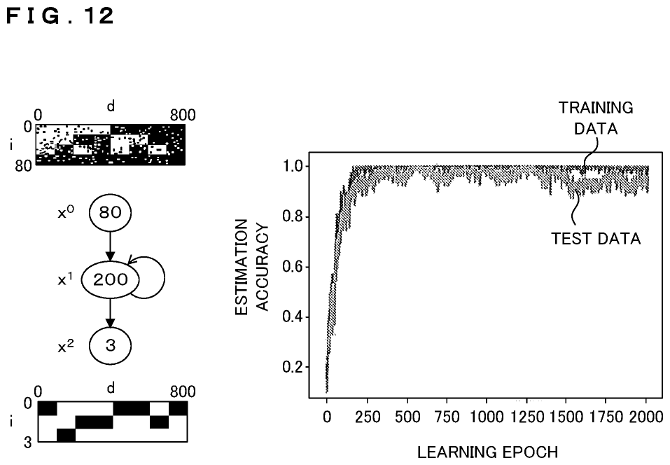

FIG. 12 is an explanatory diagram illustrating a second evaluation result by the learning method of the present embodiment. In FIG. 12, the case of a recurrent neural network that is not unidirectional connection is illustrated, in which the number of neurons in the input layer is set to 80, the number of neurons in the output layer is set to 3, and the number of neurons in the middle layers is set to 200. This network is a network that outputs an output value (i=0 to 3) for an input pixel (i=0 to 80). As illustrated in FIG. 12, it can be seen that the estimation accuracy based on the training data and the estimation accuracy based on the test data are changing in the same manner.

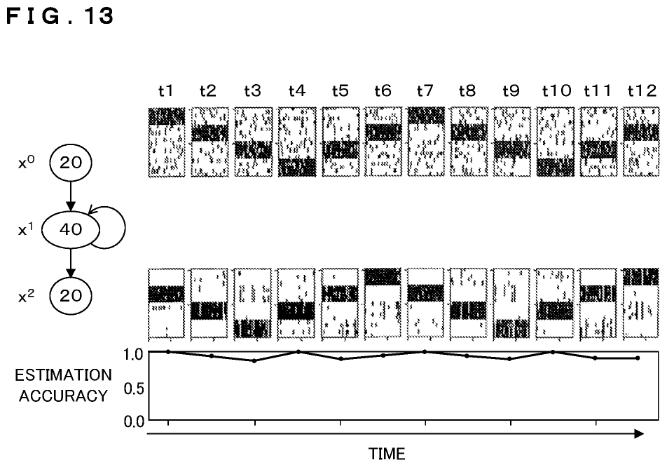

FIG. 13 is an explanatory diagram illustrating a third evaluation result by the learning method of the present embodiment. In FIG. 13, the case of a recurrent neural network is illustrated, in which the number of neurons in the input layer is set to 20, the number of neurons in the output layer is set to 20, and the number of neurons in the middle layers is set to 40. A result of learning of time series prediction using the recurrent neural network (learning with the input of the next time as the output) is illustrated. As illustrated in FIG. 13, learning is performed so that the input at time t2 is output based on the input at time t1, and learning is performed so that the input at time t3 is output based on the input at time t2. Thereafter, this description is similarly applied to other times. As illustrated in FIG. 13, the estimation accuracy based on the test data is changing at a high value. Note that even though the input data is the same at time t3 and time t5, the estimation accuracy slightly decreases as a result of depending on the past input data (time t2 for time t3 and time t4 for time t5).

### Second Embodiment

In the above-mentioned first embodiment, the state value of the neuron and the state value of the synapse are set as binary variables (random variables). However, the invention is not limited thereto. In a second embodiment, the case where the state value of the neuron and the state value of the synapse are set as continuous variables (for example, continuous values that can take a value from 0 to 1) will be described. Note that since the configuration of the information processing device 50 is similar to that of the first embodiment, a description thereof will be omitted.

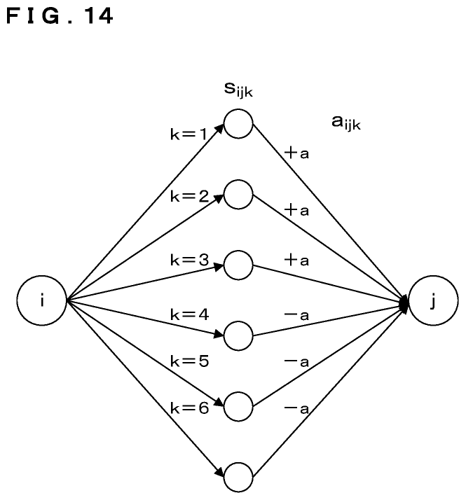

FIG. 14 is a schematic view illustrating an example of a configuration of a synapse of the second embodiment. In FIG. 14, for convenience, the number of synapses will be described as 6. By setting the state value of the synapse as a continuous value, Equation (7) can be replaced with Equation (18). σ is an activation function (for example, sigmoid function). qᵢⱼₖ is a bias term that depends on the state of the anterior neuron and the state of the posterior neuron. Note that an initial value g_{0,ijk} is set to 0.

$$\begin{matrix}{s}_{ijk} = σ ( {q}_{ijk} ) & ( 18 ) \\ \begin{matrix}{w}_{ij} = {\sum }_{k} {a}_{ijk} \cdot {s}_{ijk} \\ = {\sum }_{k} {a}_{ijk} \cdot σ ( {q}_{ijk} )\end{matrix} & ( 19 ) \\ {a}_{ijk} = \pm a & ( 20 ) \\ {w}_{ij} = \frac{K \cdot a}{2} ( σ ( a \cdot {q}_{ij} ) - σ ( - a \cdot {q}_{ij} ) ) & ( 21 ) \\ σ ( x ) - σ ( - x ) = 2 ( σ ( x ) - \frac{1}{2} ) & ( 22 ) \\ {w}_{ij} = K \cdot a ( σ ( a \cdot {q}_{ij} ) - \frac{1}{2} ) & ( 23 )\end{matrix}$$

When Equation (18) is substituted into Equation (3), the connection weight wᵢⱼ can be represented by Equation (19). Here, as shown in Equation (20), the contribution aⱼᵢₖ of each synapse to each connection weight wᵢⱼ is set to either +a or −a, half of the number K of synapses (K=6 in the example of FIG. 14) is set to +a, and the other half is set to −a. Then, the connection weight wᵢⱼ can be represented by Equation (21).

Further, for the sigmoid function σ, a formula represented by Equation (22) holds, so that the connection weight wᵢⱼ can be represented by Equation (23). qᵢⱼ is a bias value that depends on the state of the anterior neuron and the state of the posterior neuron. That is, it is unnecessary to express the connection weight wᵢⱼ between the neurons of the neural network by a large number of synapses sᵢⱼₖ. Further, a constant a may be simply 1, or may be a numerical value such as 0.1 or 0.5. It is preferable that a multiplication value a·K of the constant a and K is increased to some extent.

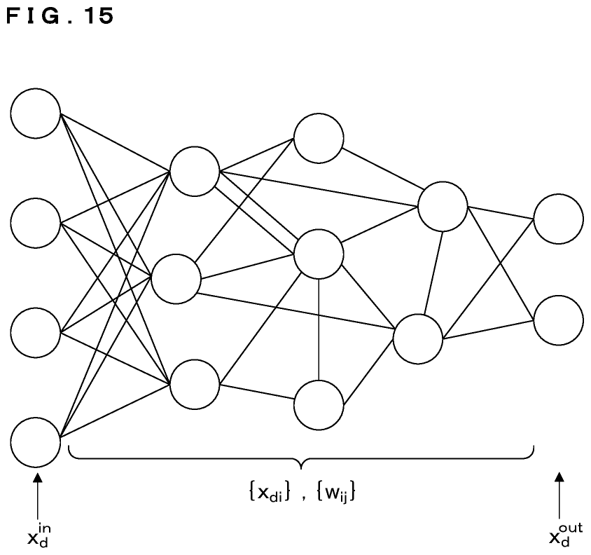

FIG. 15 is a schematic view illustrating an outline of a neural network learning method in the second embodiment. As illustrated in FIG. 15, the neurons in the input layer are fixed to a state x_{d}ⁱⁿ of the neurons corresponding to training data of a data index d. The neurons in the output layer are fixed to a state x_{d}^{out} of the neurons corresponding to training data of a data index d. The state of all neurons in the middle layers is represented by {x_{di}}. As described above, since it is unnecessary to express the connection weight wᵢⱼ between neurons of the neural network by a large number of synapses sᵢⱼₖ, the connection weight between neurons is represented by {wᵢⱼₖ} instead of the synapse sᵢⱼₖ. In the second embodiment, training data is given to a neuron of each of the input layer and the output layer of the neural network, initial data is given to a connection weight between neurons of the neural network and a neuron of the middle layers of the neural network, a state value of a neuron in the middle layers is updated, and a connection weight between neurons is updated based on the updated state value of each neuron, thereby performing learning of the neural network. Hereinafter, a specific description will be given.

First, the update of the state value of the neuron will be described.

The state value of the neuron in the middle layers is updated based on a value (also referred to as “function value”) obtained by converting the sum of the sum of signal values input to the neuron and a bias value from a posterior neuron connected to the neuron by an activation function. More specifically, the state value of the neuron in the middle layers is updated to the value converted by the activation function. The value converted by the activation function can take a value from 0 to 1. When the value converted by the activation function is, for example, 0.8, the state value of the neuron in the middle layers is updated to 0.8.

Each neuron in the middle layers can be updated based on Equation (24).

$$\begin{matrix}{x}_{di} = σ ( {v}_{di} + {b}_{di} ) & ( 24 ) \\ {b}_{di} = {\sum }_{j} \{ {x}_{dj} - σ ( {v}_{dj} ) \} \cdot {w}_{ij} & ( 25 )\end{matrix}$$

σ is an activation function (for example, sigmoid function). d is an index of data and is a mini-batch index used to update all neurons in the middle layers once.

In Equation (24), b_{di} can give a bias of a firing probability from the posterior neuron to the neuron x_{di}. That is, the presence of the retrograde bias term b_{di} makes it possible to spread information of the training data given to the neurons in the output layer to the middle layers of the network. In this sense, the bias term b_{di} can be regarded as a stochastic expression based on sampling of error propagation in the error backpropagation method. In this way, it is possible to perform learning based on the information of the training data given to the neurons in the output layer without using error backpropagation.

Next, the bias term b_{di} will be described.

The bias value from the posterior neuron is calculated based on a difference between the state value of the posterior neuron and a value obtained by converting the sum of the signal values input to the posterior neuron by the activation function. The bias value b_{di} can be calculated by Equation (25). In Equation (25), x_{dj} denotes a state value of the posterior neuron xⱼ, and σ(v_{dj}) denotes a value (function value) obtained by converting the sum of the signals input to the posterior neuron xⱼ by the activation function.

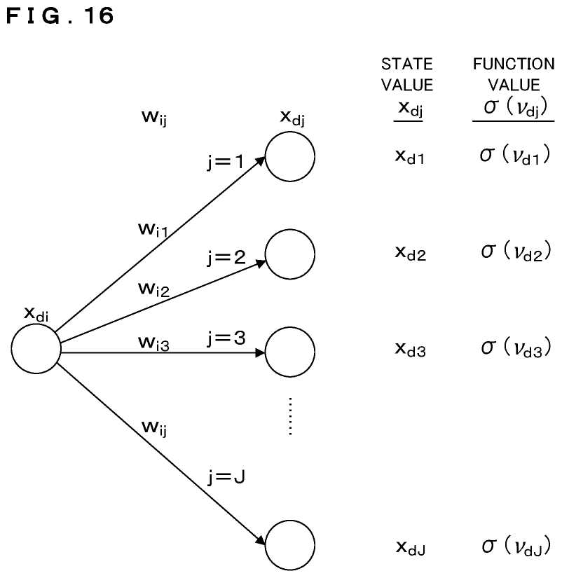

FIG. 16 is a schematic view illustrating an example of an appearance of a bias from the posterior neuron. As illustrated in FIG. 16, the posterior neuron of the neuron x_{di} is denoted by x_{dj}. j can be, for example, j=1 to J. J is the number of posterior neurons.

The meaning of Equation (25) is that when the state value x_{dj} of the posterior neuron is larger than the function value σ(v_{dj}), the bias value b_{di} becomes positive, so that (v_{di}+b_{di}) of an equation x_{di}=σ(v_{di}+b_{di}) represented by Equation (24) becomes large, which has the effect of increasing the state value of the neuron xᵢ. Further, when the state value x_{dj} of the posterior neuron is smaller than the function value σ(v_{dj}), the bias value b_{di} becomes negative, so that (v_{di}+b_{di}) of the equation x_{di}=σ(v_{di}+b_{di}) becomes smaller, which has the effect of reducing the state value of the neuron xᵢ.

As described above, Equation (25) can be regarded as retrograde error propagation, and unlike the conventional error backpropagation method, this retrograde error propagation can be implemented without the need for coordinated operation of the entire network.

Moreover, Equation (26) and Equation (27) can be used to update the state value of the neuron.

$$\begin{matrix}{x}_{di} ← ( 1 - {r}_{x} ) \cdot {x}_{di} + {r}_{x} \cdot σ ( {v}_{di} + {b}_{di} ) & ( 26 ) \\ {b}_{di} ← ( 1 - {r}_{b} ) \cdot {b}_{di} + {r}_{b} \cdot {\sum }_{j} \{ {x}_{dj} - σ ( {v}_{dj} ) \} \cdot {w}_{ij} & ( 27 )\end{matrix}$$

rₓ and r_{b} can be, for example, values greater than 0 and less than 1. As shown in Equation (27), in the update of the bias value b_{di}, the current value of b_{di} is maintained by the weighting of (1−r_{b}), the value of b_{di} is updated by the weighting of r_{b}, and the sum of the both values is set to the bias value b_{di} after the update. Further, as shown in Equation (26), in the update of the neuron x_{di}, the current value of x_{di} is maintained by the weighting of (1−rₓ), the value of x_{di} is updated by the weighting of rₓ, and the sum of the both values is set to the state value b_{di} of the neuron after the update.

Next, the update of the connection weight will be described.

The connection weight can be updated based on Equation (28) and Equation (29).

$$\begin{matrix}{w}_{ij} = K \cdot a ( σ ( a \cdot {q}_{ij} ) - \frac{1}{2} ) & ( 28 ) \\ {q}_{ij} = {\sum }_{d} {x}_{di} ( {x}_{dj} - σ ( {v}_{dj} ) ) & ( 29 )\end{matrix}$$

As shown in Equation (28), the connection weight wᵢⱼ between the anterior neuron and the posterior neuron is updated based on a value obtained by converting the bias value qᵢⱼ by the activation function. Equation (28) is the same as the above-mentioned Equation (23). The bias value qᵢⱼ is a value that depends on the state value of the anterior neuron and the state value of the posterior neuron.

Then, as shown in Equation (29), the bias value qᵢⱼ is updated based on a multiplication value obtained by multiplying the state value x_{di} of the anterior neuron by a subtraction value, which is obtained by subtracting the value σ(v_{dj}) obtained by converting the sum v_{dj} of the signal values input to the posterior neuron by the activation function from the state value x_{dj} of the posterior neuron.

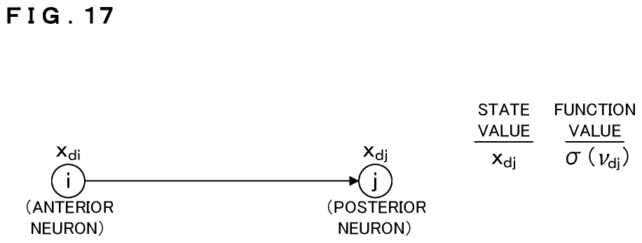

FIG. 17 is a schematic view illustrating an example of an appearance of a connection weight connecting an anterior neuron and a posterior neuron. x_{di} denotes the state value of the anterior neuron. x_{dj} denotes the state value of the posterior neuron. σ(v_{dj}) denotes a function value obtained by converting the sum of signals input to the posterior neuron xⱼ by the activation function. Equation (29) means that when the state value x_{dj} of the posterior neuron is larger than the function value σ(v_{dj}), the bias value qᵢⱼ becomes positive, so that σ(a˜qᵢⱼ) represented by Equation (28) becomes large, which has the effect of increasing the connection weight wᵢⱼ. Further, when the state value x_{dj} of the posterior neuron is smaller than the function value σ(v_{dj}), the bias value qᵢⱼ becomes negative, so that σ(a·qᵢⱼ) represented by Equation (28) becomes small, which has the effect of reducing the connection weight wᵢⱼ.

As described above, Equation (29) can be regarded as retrograde error propagation, and unlike the conventional error backpropagation method, this retrograde error propagation is can be implemented without the need for coordinated operation of the entire network.

Further, Equation (30) and Equation (31) can be used to update the connection weight.

$$\begin{matrix}{w}_{ij} ← ( 1 - {r}_{w} ) \cdot {w}_{ij} + {r}_{w} \cdot K \cdot a ( σ ( a \cdot {q}_{ij} ) - \frac{1}{2} ) & ( 30 ) \\ {q}_{ij} ← ( 1 - {r}_{q} ) \cdot {q}_{ij} + {r}_{q} \cdot {\sum }_{d} {x}_{di} ( {x}_{dj} - σ ( {v}_{dj} ) ) & ( 31 )\end{matrix}$$

r_{w} and r_{q} can be, for example, values greater than 0 and less than 1. As shown in Equation (31), in the update of the bias value qᵢⱼ, the current value of qᵢⱼ is maintained by the weighting of (1−r_{q}), the value of qᵢⱼ is updated by the weighting of r_{q}, and the sum of the both values is set to the bias value qᵢⱼ after the update. Further, as shown in Equation (30), in the update of the connection weight wᵢⱼ, the current value of wᵢⱼ is maintained by the weighting of (1−r_{w}), the value of wᵢⱼ is updated by the weighting of r_{w}, and the sum of the both values is set to the connection weight wᵢⱼ after the update.

FIG. 18 is a flowchart illustrating an example of a processing procedure of learning of the neural network of the second embodiment. The processor 51 substitutes the training data into the neurons in the input layer and the output layer (S31), and substitutes initial values into the connection weight in the neural network and the neuron in the middle layers (S32).

The processor 51 selects a neuron in the middle layers to update the bias value b_{di} based on Equation (25) or Equation (27) (S33), and updates the neuron x_{di} based on Equation (24) or Equation (26) (S34). The processor 51 determines whether or not the update of all the neurons in the middle layers is completed (S35), and when the update of all the neurons is not completed (NO in S35), processing of step S33 and subsequent steps is repeated.

When the update of all the neurons is completed (YES in S35), that is, when the update is completed using data of one index, the processor 51 determines whether or not there is training data (S36). In step S36, it is determined whether or not there is data of another index that is not used for update.

When there is training data (YES in S36), the processor 51 acquires training data of a next set (that is, a next index) (S37), and repeats processing of step S31 and subsequent steps. When there is no training data (NO in S36), the processor 51 selects connection between neurons in the neural network to update the bias value qᵢⱼ based on Equation (29) or Equation (31) (S38), and updates the connection weight wᵢⱼ based on Equation (28) or Equation (30) (S39).

The processor 51 determines whether or not update of all the connection weights in the neural network is completed (S40), and when update of all the connection weights is not completed (NO in S40), processing of step S38 and subsequent steps is repeated. When update of all the connection weights is completed (YES in S40), the processor 51 determines whether or not to repeat processing (S41).

Whether or not to repeat the processing may be determined based on whether or not the required performance is obtained by evaluating the performance of the updated connection weight, or determined based on whether or not the predetermined number of times of processing is completed. When the processing is repeated (YES in S41), the processor 51 repeats processing of step S31 and subsequent steps, and when the processing is not repeated (NO in S41), the processor 51 ends the processing.

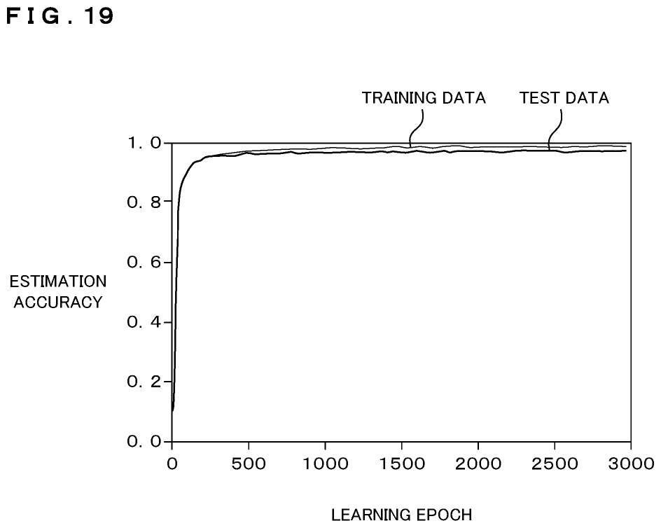

FIG. 19 is an explanatory diagram illustrating an example of an evaluation result by a learning method of the second embodiment. FIG. 19 illustrates an evaluation result using a typical handwritten character recognition data set (MNIST) frequently used in machine learning, as in the case of FIG. 11. In the case of the first embodiment, the recognition accuracy of the training data is about 95% and the recognition accuracy of the test data is about 94%, whereas in the case of the second embodiment, the recognition accuracy of the training data is about 99% and the recognition accuracy of the test data is about 97%. As described above, it can be seen that the learning accuracy tends to be improved in the case of the second embodiment. A reason therefor is considered that since the continuous value is used instead of the binary value, the state value of the neuron and the value that can be taken by the connection weight become finer. Further, as compared with the case of the first embodiment, since it is unnecessary to represent connection between neurons in the neural network with a large number of synapses, the number of variables required for learning can be significantly reduced, and the calculation time by the GPU, etc. can be reduced accordingly, which facilitates implementation on a computer.

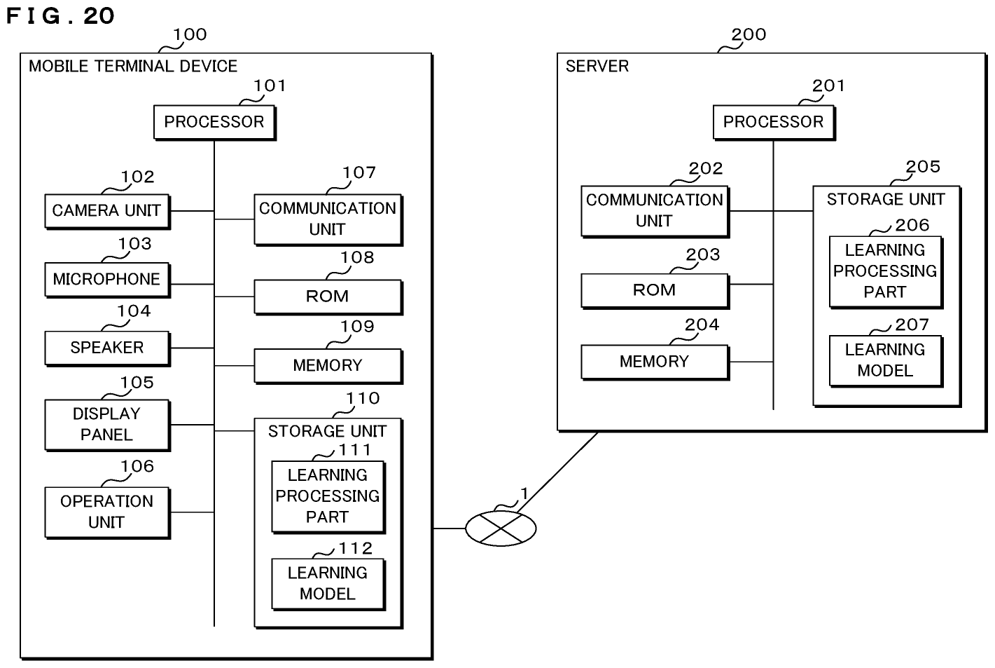

FIG. 20 is a block diagram illustrating an example of a configuration of a mobile terminal device 100. The mobile terminal device 100 can be connected to a server 200 as a learning processing device via a communication network. The mobile terminal device 100 includes a processor 101 that controls the entire device, a camera unit 102, a microphone 103, a speaker 104, a display panel 105, an operation unit 106, a communication unit 107, a ROM 108, a memory 109, and a storage unit 110. The storage unit 110 stores a learning processing part 111 and a learning model 112 including computer programs and data for performing learning of the neural network. The learning processing part 111 and the learning model 112 have similar configurations to those of the example of FIG. 9.

The camera unit 102 can capture an image (including a moving image). The microphone 103 can acquire audio data. The speaker can output audio.

The communication unit 107 has a communication function with the communication unit 202 of the server 200 via the communication network 1. Note that the communication unit 107 can transmit and receive information to and from other devices (not illustrated). Since the display panel 105, the operation unit 106, the ROM 108, the memory 109, and the storage unit 110 are similar to those of the example of FIG. 9, a description thereof will be omitted.

The learning model 112 as a trained device has a neural network, and is trained by the neural network learning method of the present embodiment or is generated by the neural network generation method of the present embodiment. Note that the learning model 112 can be retrained by the learning processing part 111. When the learning model 112 is not retrained, the learning processing part 111 may not be provided.

The learning model 112 is generated or trained by using at least one of image data, audio data, and character string data as training data. Note that the learning of the learning model 112 may be unsupervised learning without a teacher label or supervised learning with a teacher label.

By generating or training the learning model 112 using the image data as training data, for example, the mobile terminal device 100 can recognize a person or an object in an image captured by the camera unit 102. Further, a recognition result can be output as audio from the speaker 104.

By generating or training the learning model 112 using the audio data as training data, for example, the mobile terminal device 100 can understand content based on audio of the other party acquired by the microphone 103, and output audio from the speaker 104 to communicate with the other party.

By generating or training the learning model 112 using the character string data as training data, for example, the mobile terminal device 100 can understand content of character information reflected in an image captured by the camera unit 102 or character information acquired via the communication unit 107, and display a summary of the character information, response content with respect to the character information, etc. on the display panel 105 or output audio from the speaker 104.

The server 200 has a function as a learning processing device. The server 200 includes a processor 201, a communication unit 202, a ROM 203, a memory 204, and a storage unit 205. The learning processing part 206 and the learning model 207 are stored in the storage unit 205. The ROM 203, the memory 204, the storage unit 205, the learning processing part 206, and the learning model 207 are similar to those of the example of FIG. 9. The server 200 may be configured as one server, or may be configured as a plurality of servers. In this case, each part of the server 200 can be distributed and configured among the plurality of servers, and for example, at least one of the learning processing part 206 and the learning model 207 can be provided in another server different from the server 200. Further, the learning processing part 206 and the learning model 207 may be provided in other servers different from the server 200, respectively.

The learning processing part 206 (which may include the processor 201) can execute a process of setting each neuron in the neural network to a random variable that can take a binary value, a process of expressing a connection weight between neurons in the neural network as a plurality of synapses obtained by multiplying each synapse by a required connection coefficient, and setting the plurality of synapses to random variables allowed to take binary values, a process of giving training data to neurons in each of the input layer and output layer and giving initial data to neurons in the middle layers, a process of repeatedly updating each state value of each neuron in the middle layers and each synapse in the neural network by performing sampling based on the Markov chain Monte Carlo method from a conditional probability distribution under a condition that a random variable of a neuron in each of the input layer and the output layer is a value of the training data, and a process of calculating a connection weight between neurons based on the updated state value of each synapse.

The mobile terminal device 100 can download the trained learning model 207 from the server 200 and store the trained learning model 207 in the storage unit 110. In this case, the mobile terminal device 100 can download the learning model 207 retrained by the learning processing part 206 of the server 200 and update the learning model 112. When the learning model is downloaded from the server 200, the mobile terminal device 100 may not include the learning processing part 111.

It is to be noted that, as used herein and in the appended claims, the singular forms “a”, “an”, and “the” include plural referents unless the context clearly dictates otherwise.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1-19. (canceled)

20. A neural network learning method, comprising:
setting each neuron in a neural network to a random variable allowed to take a binary value;
expressing a connection weight between neurons in the neural network as a plurality of synapses obtained by multiplying each synapse by a required connection coefficient, and setting the plurality of synapses to random variables allowed to take binary values;
giving training data to a neuron in each of an input layer and an output layer, and giving initial data to a neuron in a middle layer;
repeating a process of updating each state value of each neuron in the middle layer and each synapse in the neural network by performing sampling based on a Markov chain Monte Carlo method from a conditional probability distribution under a condition that a random variable of a neuron in each of the input layer and the output layer is a value of the training data; and
calculating a connection weight between neurons based on the updated state value of each synapse.

21. The neural network learning method according to claim 20, wherein a state value of a neuron in the middle layer is updated based on a value obtained by converting a sum of a sum of signal values input to the neuron and a bias value from a posterior neuron connected to the neuron by an activation function.

22. The neural network learning method according to claim 21, wherein the bias value from the posterior neuron is calculated based on a difference between a state value of the posterior neuron and an expected value of the posterior neuron.

23. The neural network learning method according to claim 20, wherein state values of a plurality of synapses connecting an anterior neuron and a posterior neuron are updated to values based on a state value of the anterior neuron and a state value of the posterior neuron.

24. The neural network learning method according to claim 20, wherein state values of a plurality of synapses connecting an anterior neuron and a posterior neuron are updated based on a value obtained by converting a value obtained by multiplying a state value of the anterior neuron by a difference between a state value of the posterior neuron and an expected value of the posterior neuron by an activation function.

25. The neural network learning method according to claim 20, wherein a state value of each synapse in the neural network is updated using an updated state value of each neuron in the middle layer.

26. A neural network learning method, comprising:
giving training data to a neuron in each of an input layer and an output layer of a neural network;
giving initial data to a connection weight between neurons of a neural network and a neuron in the middle layer of the neural network;
updating a state value of a neuron in the middle layer based on a value obtained by converting a sum of a sum of signal values input to the neuron and a bias value from a posterior neuron connected to the neuron by an activation function; and
updating a connection weight between neurons based on an updated state value of each neuron.

27. The neural network learning method according to claim 26, wherein the bias value from the posterior neuron is calculated based on a difference between a state value of the posterior neuron and a value obtained by converting a sum of input values input to the posterior neuron by an activation function.

28. The neural network learning method according to claim 26, wherein a connection weight between an anterior neuron and a posterior neuron is updated based on a value obtained by converting a bias value based on a state value of the anterior neuron and a state value of the posterior neuron by an activation function.

29. The neural network learning method according to claim 28, wherein the bias value is updated based on a multiplication value obtained by multiplying a state value of the anterior neuron by a subtraction value obtained by subtracting a value obtained by converting a sum of signal values input to the posterior neuron by an activation function from a state value of the posterior neuron.

30. A neural network generation method, comprising:
setting each neuron in a neural network to a random variable allowed to take a binary value;
expressing a connection weight between neurons in the neural network as a plurality of synapses obtained by multiplying each synapse by a required connection coefficient, and setting the plurality of synapses to random variables allowed to take binary values;
giving training data to a neuron in each of an input layer and an output layer, and giving initial data to a neuron in a middle layer;
repeating a process of updating each state value of each neuron in the middle layer and each synapse in the neural network by performing sampling based on a Markov chain Monte Carlo method from a conditional probability distribution under a condition that a random variable of a neuron in each of the input layer and the output layer is a value of the training data; and
generating a neural network by calculating a connection weight between neurons based on an updated state value of each synapse.

31. A neural network generation method, comprising:
giving training data to a neuron in each of an input layer and an output layer of a neural network;
giving initial data to a connection weight between neurons of a neural network and a neuron in the middle layer of the neural network;
updating a state value of a neuron in the middle layer based on a value obtained by converting a sum of a sum of signal values input to the neuron and a bias value from a posterior neuron connected to the neuron by an activation function; and
updating a connection weight between neurons based on an updated state value of each neuron.

32. A trained device having a neural network, the trained device being generated by causing a computer to execute processes of:
setting each neuron in the neural network to a random variable allowed to take a binary value;
expressing a connection weight between neurons in the neural network as a plurality of synapses obtained by multiplying each synapse by a required connection coefficient, and setting the plurality of synapses to random variables allowed to take binary values;
giving training data to a neuron in each of an input layer and an output layer, and giving initial data to a neuron in a middle layer;
repeatedly updating each state value of each neuron in the middle layer and each synapse in the neural network by performing sampling based on a Markov chain Monte Carlo method from a conditional probability distribution under a condition that a random variable of a neuron in each of the input layer and the output layer is a value of the training data; and
calculating a connection weight between neurons based on the updated state value of each synapse.

33. A trained device having a neural network, the trained device being generated by causing a computer to execute processes of:
giving training data to a neuron in each of an input layer and an output layer of the neural network;
giving initial data to a connection weight between neurons of a neural network and a neuron in the middle layer of the neural network;
updating a state value of a neuron in the middle layer based on a value obtained by converting a sum of a sum of signal values input to the neuron and a bias value from a posterior neuron connected to the neuron by an activation function; and
updating a connection weight between neurons based on an updated state value of each neuron.

34. A mobile terminal device, comprising
the trained device according to claim 32,
the trained device being generated using at least one of image data, audio data, and character string data as training data.

35. A mobile terminal device, comprising
the trained device according to claim 33,
the trained device being generated using at least one of image data, audio data, and character string data as training data.

36. A learning processing device, comprising
a processor,
the learning processing device training a neural network,
the processor executing processes of
setting each neuron in the neural network to a random variable allowed to take a binary value,
expressing a connection weight between neurons in the neural network as a plurality of synapses obtained by multiplying each synapse by a required connection coefficient, and setting the plurality of synapses to random variables allowed to take binary values,
giving training data to a neuron in each of an input layer and an output layer, and giving initial data to a neuron in a middle layer,
repeatedly updating each state value of each neuron in the middle layer and each synapse in the neural network by performing sampling based on a Markov chain Monte Carlo method from a conditional probability distribution under a condition that a random variable of a neuron in each of the input layer and the output layer is a value of the training data, and
calculating a connection weight between neurons based on the updated state value of each synapse.

37. A learning processing device, comprising
a processor,
the learning processing device training a neural network,
the processor executing processes of
giving training data to a neuron in each of an input layer and an output layer of a neural network,
giving initial data to a connection weight between neurons of a neural network and a neuron in the middle layer of the neural network,
updating a state value of a neuron in the middle layer based on a value obtained by converting a sum of a sum of signal values input to the neuron and a bias value from a posterior neuron connected to the neuron by an activation function, and
updating a connection weight between neurons based on an updated state value of each neuron.

38. A computer readable non-transitory recording medium recording a computer program causing a computer to execute processes of:
setting each neuron in a neural network to a random variable allowed to take a binary value;
expressing a connection weight between neurons in the neural network as a plurality of synapses obtained by multiplying each synapse by a required connection coefficient, and setting the plurality of synapses to random variables allowed to take binary values;
giving training data to a neuron in each of an input layer and an output layer, and giving initial data to a neuron in a middle layer;
repeatedly updating each state value of each neuron in the middle layer and each synapse in the neural network by performing sampling based on a Markov chain Monte Carlo method from a conditional probability distribution under a condition that a random variable of a neuron in each of the input layer and the output layer is a value of the training data; and
calculating a connection weight between neurons based on the updated state value of each synapse.

39. A computer readable non-transitory recording medium recording a computer program causing a computer to execute processes of:
giving training data to a neuron in each of an input layer and an output layer of a neural network;
giving initial data to a connection weight between neurons of a neural network and a neuron in the middle layer of the neural network;
updating a state value of a neuron in the middle layer based on a value obtained by converting a sum of a sum of signal values input to the neuron and a bias value from a posterior neuron connected to the neuron by an activation function; and
updating a connection weight between neurons based on an updated state value of each neuron.
